(19) United States
(12) Patent Application Publication
(10) Pub. No.: US 2009/0301084 A1
(43) Pub. Date: Dec. 10, 2009

(54) Air Control System for Charge Control of Engine and Method Thereof

(75) Inventor: Sungha LEE, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/343,222

(22) Filed: Dec. 23, 2008

(30) Foreign Application Priority Data
Jun. 9, 2008 (KR) 10-2008-0053750

(51) Int. Cl. F02D 23/00

(52) U.S. Cl. 60/602

(57) ABSTRACT

An air control system for charge control of an engine and a method thereof. An air cut-off valve is installed between an air tank supplying compressed air and a wastegate control valve adjusting an opening degree of a wastegate valve. The air cut-off valve is configured to cut off a channel when an idle validation switch signal is inputted into an engine control unit.

### CROSS-REFERENCE TO RELATED APPLICATIONS

The present application claims priority to Korean Application Serial Number 10-2008-0053750, filed on Jun. 9, 2008, the entire contents of which are incorporated herein for all purposes by this reference.

### BACKGROUND OF THE INVENTION

1. Field of the Invention

The present invention relates to an air control system and a method thereof for preventing air for control of a wastegate control valve for controlling an opening degree of a wastegate valve of a turbo charger from being consistently consumed in engine idle.

2. Description of Related Art

The control of a (compressed) natural gas engine is divided into intake air amount control, injection fuel amount control, and ignition timing control. In particular, since the natural gas engine is an air-fuel ratio control engine, it is very important to control an intake air amount.

The control of the intake air amount in the natural gas engine is achieved by controlling a charging degree of a turbo charger through adjusting a bypass amount of exhaust gas by controlling an opening degree of a wastegate valve of the turbo charger

An overall configuration of an intake/exhaust system is shown in FIG. 1.

A compressor 1a and a turbine 1b of a turbo charger 1 are installed on an intake pipe and an exhaust pipe of an engine 2, respectively, and are interconnected on the same shaft to rotate integrally.

A wastegate valve 3 is installed on the exhaust pipe to form a bypass passage connecting a front portion and a rear portion of the turbine 1b. The opening degree of the wastegate valve 3 is controlled by a diaphragm 3a operated by air pressure. Compressed air providing actuating pressure to the diaphragm 3a is generated by an air compressor 4 interlocked with the engine, and the compressed air is stored in an air tank 5 and is supplied to a wastegate control valve 6, thereby acting on the diaphragm 3a.

In the control of the opening degree of the wastegate valve 3, an engine control unit 7 controls an amount of the compressed air, which is supplied from air tank 5, discharged into the air by controlling the opening degree of wastegate control valve 6 in a PWM (Pulse Width Modulation) method to control an opening degree of a valve plate of wastegate valve 3 by allowing remaining air not discharged into the air to act on diaphragm 3a.

Since actuation force is not applied to diaphragm 3a when wastegate control valve 6 discharges all the air supplied from air tank 5 into the air, wastegate valve 3 is closed, whereby a charge amount reaches the maximum, while, when all the air acts on diaphragm 3a without the air discharged into the air by fully closing wastegate control valve 6, wastegate valve 3 is fully opened, whereby the bypass amount of the exhaust gas reaches the maximum and the charge amount reaches the minimum.

The opening degree of wastegate valve 3 is linearly controlled in proportion to a PWM signal of engine control unit 7. The charge amount is controlled to be large by closing wastegate valve 3 in the engine idle so that a vehicle can rapidly start in consideration of start responsibility of the vehicle.

Accordingly, engine control unit 7 is continuously discharging the air supplied to air tank 5 into the air by fully opening wastegate control valve 6 in order to maintain a closed state of wastegate valve 3.

However, for such a reason, since the air in air tank 5 is continuously exhausted and air compressor 4 continuously is actuated, a load of the engine increases. In addition, since newly input compressed air is instantly charged in air tank 5, moisture is not sufficiently removed by an air dryer 8 installed between air compressor 4 and air tank 5, thereby causing an air line to be frozen in the winter.

Accordingly, in a case when an output of the engine is reduced and the air line is clogged due to freezing, the air is not smoothly supplied to air tank 5, whereby the charge control using wastegate control valve 6 and wastegate valve 3 is not normally performed. Therefore, the control of an amount of intake air of the engine is not normally performed.

Reference numeral 9 represents an air pressure regulator serving as reducing high pressure of air tank 5 to proper pressure, for example, 9 bar to 2 bar.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an air control system for charge control of an engine and a method thereof in which air is prevented from being continuously discharged by a wastegate control valve while a closed state of a wastegate valve is maintained in engine idle, an output of the engine is prevented from being lowered due to continuous actuation of an air compressor by preventing air in the air tank from being exhausted and an air line is prevented from being clogged due to moisture freezing in the winter by securing a sufficient dehumidifying time of the air supplied from the air tank.

In an aspect of the present invention, a control system for charge control of an engine, may include a turbo charger installed in intake and exhaust pipes of the engine, a wastegate valve installed in the exhaust pipe to bypass exhaust gas into downstream the exhaust pipe, a wastegate control valve receiving air supplied from an air tank and supplying a portion of the air as actuating air for controlling the wastegate valve, an air cut-off valve installed downstream the air tank through an air supply channel fluidly-connecting the air tank and the wastegate control valve, and an control unit controlling operations of the wastegate control valve and the air cut-off valve.

The air cut-off valve may be on/off-controlled by the control unit.

The air cut-off valve may cut off the air supply channel in an ON state and opens the air supply channel in an OFF state.

The air cut-off valve may be a solenoid valve.

The control unit may generate an air cut-off valve ON signal to the air cut-off valve when an idle validation switch signal (IVS) is inputted thereto.

The IVS signal may be generated in acceleration pedal to determine an idle state in driving.

The control unit may control the wastegate control valve in accordance with foot pedal position (FPP) signal when the IVS signal is not inputted.

The FPP signal may be determined by a control amount of acceleration pedal.

The control unit may generate an air cut-off valve OFF signal to the air cut-off valve when the IVS signal is not inputted.

The control unit may control the wastegate control valve in accordance with foot pedal position (FPP) signal when the idle validation switch signal is not inputted.

The FPP signal may be determined by a control amount of acceleration pedal.

In another aspect of the present invention, an air control method for charge control of an engine may include an idle signal inputting step of determining whether or not an idle validation switch signal (IVS) is inputted, and an air cut-off valve actuating step cutting off an air supply channel to a wastegate control valve by generating an air cut-off valve ON signal to an air cut-off valve when the IVS signal is inputted and opening the air supply channel by generating an air cut-off valve OFF signal to the air cut-off valve when the IVS signal is not inputted, in the IVS signal inputting step.

The method may further include a wastegate control valve actuating step of fully opening the wastegate control valve when the air cut-off valve is in an ON state and adjusting an opening amount of the wastegate control valve in proportion to a foot pedal position (FPP) signal when the air cut-off valve is in an OFF state, in the air cut-off valve actuating step.

The control unit may linearly control the opening amount of the wastegate control valve in a PWM method in accordance with the foot pedal position signal when the IVS signal is not inputted, in the wastegate control valve actuating step.

The method may further include a wastegate valve actuating step of fully cutting off the wastegate valve when the wastegate control valve is fully opened and controlling an opening amount of the wastegate valve in accordance with the opening amount of the wastegate control valve when the opening amount of the wastegate control valve is controlled in accordance with the FPP signal, in the wastegate control valve actuating step.

In further another aspect of the present invention, an air control method for charge control of an engine, may include an idle signal inputting step of determining whether or not an idle validation switch signal (IVS) is inputted, an air cut-off valve actuating step cutting off an air supply channel to a wastegate control valve by generating an air cut-off valve ON signal to an air cut-off valve when the IVS signal is inputted and opening the air supply channel by generating an air cut-off valve OFF signal to the air cut-off valve when the IVS signal is not inputted, in the IVS signal inputting step, a wastegate control valve actuating step of fully opening the wastegate control valve when the air cut-off valve is in an ON state and adjusting an opening amount of the wastegate control valve in proportion to a foot pedal position (FPP) signal when the air cut-off valve is in an OFF state, in the air cut-off valve actuating step, and a wastegate valve actuating step of fully cutting off the wastegate valve when the wastegate control valve is fully opened and controlling an opening amount of the wastegate valve in accordance with the opening amount of the wastegate control valve when the opening amount of the wastegate control valve is controlled in accordance with the FPP signal, in the wastegate control valve actuating step.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 a diagram illustrating a configuration of a general charge control system for control of an amount of intake air.

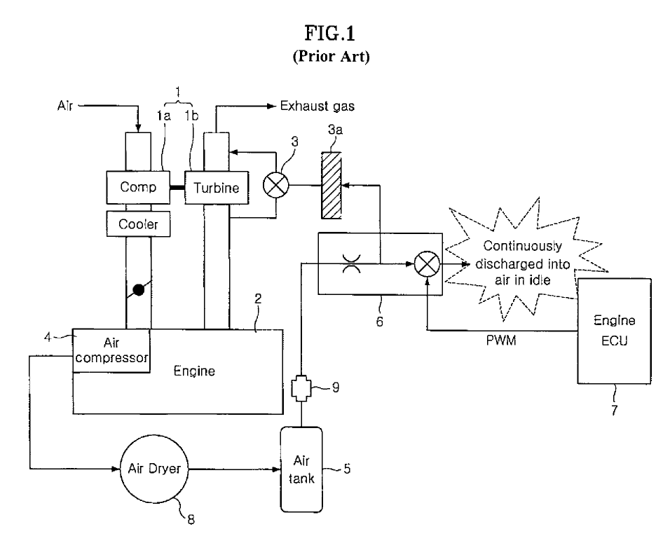

FIG. 2 is a diagram illustrating a configuration of an exemplary air control system for charge control of an engine according to the present invention.

FIG. 3 is a flowchart of an exemplary air control method for charge control of an engine according to the present invention.

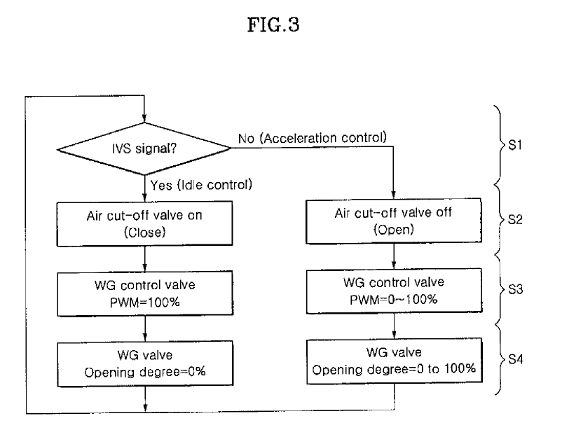

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

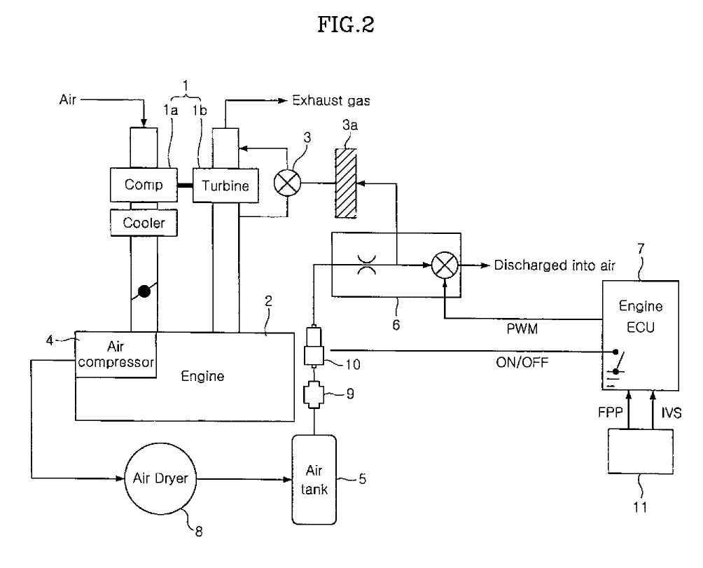

Referring to FIG. 2, in an intake/exhaust system of a natural gas engine, a turbo charger 1 is installed in an intake/exhaust pipe of an engine 2 and turbo charger 1 includes a wastegate valve 3 of which opening degree is controlled by a diaphragm 3a actuated by air pressure.

Turbo charger 1 further includes a wastegate control valve 6 to control the opening degree of wastegate valve 3. Compressed air for controlling wastegate control valve 6 is generated by an air compressor 4 actuated by engine 2 and is stored in an air tank 5. The compressed air is decompressed to proper pressure through an air pressure regulator 9 and is supplied to wastegate control valve 6.

An air dryer 8 is provided between air compressor 4 and air tank 5 in order to remove moisture contained in air.

The opening degree of wastegate control valve 6 is controlled by a PWM signal transmitted from an engine control unit 7.

In the above-described configuration, according to various embodiments of the present invention, an air cut-off valve 10 is installed on a flow channel between air tank 5 and wastegate control valve 6. More specifically, air cut-off valve 10 is installed at a portion (a direction of a wastegate control valve side) downstream the air pressure regulator 9.

Air cut-off valve 10, which is on/off-controlled by engine control unit 7, cuts off the flow channel in an ON state and opens the flow channel in an OFF state.

Air cut-off valve on and off signals of engine control unit 7 follows an IVS (Idle Validation Switch) signal generated in accordance with an operation state of an acceleration pedal 11. That is, when the idle validation switch signal is inputted, the air cut-off valve ON signal is generated and when the idle validation switch signal is not inputted, the air cut-off valve OFF signal is generated.

Hereinafter, an air control method for charge control of an engine will be described.

According to other embodiments of the present invention, an air control method for charge control of an engine includes an idle validation signal inputting step S1 of determining whether or not an IVS signal is inputted from acceleration pedal 11; an air cut-off valve actuating step S2 of allowing an air cut-off valve 10 to cut off an air supply channel to a wastegate valve 6 by generating an air cut-off valve ON signal when the IVS signal is inputted in accordance with input or not of the IVS signal and allowing the air cut-off valve to open the air supply channel by an air cut-off valve OFF signal when the IVS signal is not inputted; a wastegate control valve actuating step S3 of fully opening wastegate control valve 6 by setting a PWM amount of wastegate control valve 6 to 100% when air cut-off valve 10 is in an ON state and adjusting the PWM amount of wastegate control valve 6 in the range of 0 to 100% in proportion to a food pedal position (FPP) signal, that is, an operation quantity of acceleration pedal 11 when air cut-off valve 10 is in an OFF state, in air cut-off actuating step S2; and a wastegate valve actuating step S4 in which a wastegate valve 3 is fully cut off to acquire the maximum charge amount when wastegate control valve 6 is fully opened and the opening degree of wastegate control valve 6 is controlled in accordance with the PWM signal to adjust the opening degree of wastegate valve 3, in wastegate control valve actuating step S3.

That is, the IVS signal generated in acceleration pedal 11 is inputted into an engine control unit 7 when a driving state of an engine is converted into an idle state in driving (IVS signal input step S1)

Subsequently, engine control unit 7 generates the air cut-off valve ON signal and air cut-off valve 10 receiving the air cut-off on signal cuts off a channel from an air tank 5 to wastegate control valve 6 (air cut-off valve actuating step S2).

At this time, since the engine is in an idle state, a PWM signal inputted into wastegate control valve 6 from engine control unit 7 is a valve full-opening signal (PWM=100%), whereby wastegate control valve 6 is in a fully opened state (wastegate control valve actuating step S3)

Accordingly, air supplied from air tank 5 is discharged into the air and is not supplied to a diaphragm 3a of wastegate valve 3 through wastegate control valve 6.

Hence, wastegate valve 3 is in a closed state (opening degree of 0%) and thus exhaust gas is not bypassed through wastegate valve 3, whereby intake air is charged in the idle state in the same manner as related art

At this time, only air remaining on the channel between air cut-off valve 10 and wastegate control valve 6 is discharged into the air and air remaining in air tank 5 is not discharged by air cut-off valve 10, whereby compressed air in air tank 5 is not exhausted.

Therefore, since it is unnecessary to actuate an air compressor 4 for charging the exhausted air, a reduction in output of the engine caused due to the actuation of air compressor 4 does not occur.

For the same reason, since it is unnecessary to rapidly charge the compressed air in air tank 5, air sufficiently not humidified in an air dryer 8 is not supplied to air tank 5. Accordingly, an air line is not frozen in the winter season, thereby preventing an amount of the intake air from being not normally controlled due to freezing of the air line.

Meanwhile, since the IVS signal is not inputted when a vehicle is again actuated (IVS signal inputting step S1), normal acceleration control is achieved in accordance with the foot pedal position (FPP) signal generated depending on a control amount of acceleration pedal 11.

That is, when the IVS signal is not inputted, engine control unit 7 allows the compressed air to be normally supplied to wastegate control valve 6 from air tank 5 by opening the channel through turning off air cut-off valve 10 (air cut-off valve actuating step S2).

Engine control unit 7 generates the PWM signal for linearly controlling the opening degree of wastegate control valve 6 in accordance with the foot pedal position signal inputted from acceleration pedal 11 and the opening degree of wastegate control valve 6 is controlled by the PWM signal (wastegate control valve actuating step S3).

Accordingly, a part of the air supplied from air tank 5 in accordance with the opening degree of wastegate control valve 6 is discharged into the air and the rest remaining air acts on diaphragm 3a of wastegate valve 3 as actuation air to control the opening degree of wastegate valve 3 (wastegate valve actuating step S4), whereby the amount of the intake air of engine 2 is controlled in accordance with the FPP signal in the same manner as a case in which air cut-off valve 10 is not installed.

For convenience in explanation and accurate definition in the appended claims, the terms “front” and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control system for charge control of an engine, comprising:
a turbo charger installed in intake and exhaust pipes of the engine;
a wastegate valve installed in the exhaust pipe to bypass exhaust gas into downstream the exhaust pipe;
a wastegate control valve receiving air supplied from an air tank and supplying a portion of the air as actuating air for controlling the wastegate valve;
an air cut-off valve installed downstream the air tank through an air supply channel fluidly-connecting the air tank and the wastegate control valve; and
an control unit controlling operations of the wastegate control valve and the air cut-off valve.

2. The system as defined in claim 1, wherein the air cut-off valve is on/off-controlled by the control unit, the air cut-off valve cuts off the air supply channel in an ON state and opens the air supply channel in an OFF state, and the air cut-off valve is a solenoid valve.

3. The system as defined in claim 1, wherein the control unit generates an air cut-off valve ON signal to the air cut-off valve when an idle validation switch signal (IVS) is inputted thereto.

4. The system as defined in claim 3, wherein the IVS signal is generated in acceleration pedal to determine an idle state in driving.

5. The system as defined in claim 3, wherein the control unit controls the wastegate control valve in accordance with foot pedal position (FPP) signal when the IVS signal is not inputted.

6. The system as defined in claim 5, wherein the FPP signal is determined by a control amount of acceleration pedal.

7. The system as defined in claim 3, wherein the control unit generates an air cut-off valve OFF signal to the air cut-off valve when the IVS signal is not inputted.

8. The system as defined in claim 7, wherein the control unit controls the wastegate control valve in accordance with foot pedal position (FPP) signal when the idle validation switch signal is not inputted.

9. An air control method for charge control of an engine, comprising:
an idle signal inputting step of determining whether or not an idle validation switch signal (IVS) is inputted; and
an air cut-off valve actuating step cutting off an air supply channel to a wastegate control valve by generating an air cut-off valve ON signal to an air cut-off valve when the IVS signal is inputted and opening the air supply channel by generating an air cut-off valve OFF signal to the air cut-off valve when the IVS signal is not inputted, in the IVS signal inputting step.

10. The method as defined in claim 9 further comprising:
a wastegate control valve actuating step of fully opening the wastegate control valve when the air cut-off valve is in an ON state and adjusting an opening amount of the wastegate control valve in proportion to a foot pedal position (FPP) signal when the air cut-off valve is in an OFF state, in the air cut-off valve actuating step.

11. The method as defined in claim 10, wherein the control unit linearly controls the opening amount of the wastegate control valve in a PWM method in accordance with the foot pedal position signal when the IVS signal is not inputted, in the wastegate control valve actuating step.

12. The method as defined in claim 10 further comprising:
a wastegate valve actuating step of fully cutting off the wastegate valve when the wastegate control valve is fully opened and controlling an opening amount of the wastegate valve in accordance with the opening amount of the wastegate control valve when the opening amount of the wastegate control valve is controlled in accordance with the FPP signal, in the wastegate control valve actuating step.

13. An air control method for charge control of an engine, comprising:
an idle signal inputting step of determining whether or not an idle validation switch signal (IVS) is inputted;
an air cut-off valve actuating step cutting off an air supply channel to a wastegate control valve by generating an air cut-off valve ON signal to an air cut-off valve when the IVS signal is inputted and opening the air supply channel by generating an air cut-off valve OFF signal to the air cut-off valve when the IVS signal is not inputted, in the IVS signal inputting step;
a wastegate control valve actuating step of fully opening the wastegate control valve when the air cut-off valve is in an ON state and adjusting an opening amount of the wastegate control valve in proportion to a foot pedal position (FPP) signal when the air cut-off valve is in an OFF state, in the air cut-off valve actuating step; and
a wastegate valve actuating step of fully cutting off the wastegate valve when the wastegate control valve is fully opened and controlling an opening amount of the wastegate valve in accordance with the opening amount of the wastegate control valve when the opening amount of the wastegate control valve is controlled in accordance with the FPP signal, in the wastegate control valve actuating step.
